(19) United States
(12) Patent Application Publication
(10) Pub. No.: US 2019/0051021 A1
(43) Pub. Date: Feb. 14, 2019

(54) INFORMATION PROCESSING APPARATUS

(71) Applicant: FUJI XEROX CO., LTD., Tokyo (JP)

(72) Inventors: Qianru QIU, Kanagawa (JP); Kengo OMURA, Kanagawa (JP)

(73) Assignee: FUJI XEROX CO., LTD., Tokyo (JP)

(21) Appl. No.: 15/935,061

(22) Filed: Mar. 26, 2018

(30) Foreign Application Priority Data
Aug. 10, 2017 (JP) 2017-154995

(51) Int. Cl. G06T 11/00; G06T 7/90

(52) U.S. Cl. CPC G06T 11/001; G06T 2200/24; G06T 7/90

(57) ABSTRACT

An information processing apparatus includes an acquisition unit, an extraction unit, a receiving unit, and a specifying unit. The acquisition unit acquires an image. The extraction unit extracts a representative color which is a color representative of the image acquired by the acquisition unit. The receiving unit receives a designated word indicating emotion. The specifying unit specifies a color scheme to be applied to an image which is generated by a user, by using the word and the representative color.

### CROSS-REFERENCE TO RELATED APPLICATIONS

This application is based on and claims priority under 35 USC 119 from Japanese Patent Application No. 2017-154995 filed Aug. 10, 2017.

### BACKGROUND

The present invention relates to an information processing apparatus.

### SUMMARY

According to an aspect of the invention, there is provided an information processing apparatus including an acquisition unit that acquires an image, an extraction unit that extracts a representative color which is a color representative of the image acquired by the acquisition unit; a receiving unit that receives a designated word indicating emotion, and a specifying unit that specifies a color scheme to be applied to an image which is generated by a user, by using the word and the representative color.

### BRIEF DESCRIPTION OF THE DRAWINGS

Exemplary embodiment(s) of the present invention will be described in detail based on the following figures, wherein:

FIG. 1 is a diagram illustrating a configuration of an information processing apparatus 1 according to an exemplary embodiment;

FIGS. 2A to 2C are diagrams illustrating various databases and rule bases stored in a memory 12;

FIG. 3 is a view for explaining types of colors constituting a color scheme;

FIGS. 4A and 4B are diagrams for explaining hue and tone commonalities;

FIG. 5 is a diagram illustrating a functional configuration of the information processing apparatus 1;

FIGS. 6A and 6B are flowcharts illustrating a flow of an operation of extracting a representative color and a color scheme candidate of the information processing apparatus 1;

FIG. 7 is a view illustrating an example of a hue and a tone specified from gradation values of the representative color;

FIGS. 8A and 8B are diagrams illustrating examples of hues and tones specified from each color scheme candidate;

FIG. 9 is a flowchart illustrating a flow of an operation for specifying a color scheme of the information processing apparatus 1;

FIGS. 10A and 10B are diagrams illustrating an example of determining a commonality between a representative color and a color scheme candidate;

FIG. 11 is a flowchart illustrating a flow of an operation of a text color specifying process of the information processing apparatus 1;

FIG. 12 is a diagram for explaining a region where text is disposed in a photograph;

FIG. 13 is a view illustrating an example of a hue and a tone specified from gradation values of the representative color of a region where text is disposed in a photograph;

FIG. 14 is a diagram for explaining text color candidates based on a specified color scheme;

FIGS. 15A and 15B are diagrams illustrating an example of determining readability of a representative color and a text color candidate of a region on a photograph on which text is disposed;

FIG. 16 is a flowchart illustrating a flow of an operation for specifying a color scheme in Modification Example 4; and

FIG. 17 is a flowchart illustrating a flow of an operation for specifying a color scheme in Modification Example 5.

### DETAILED DESCRIPTION

### 1. Exemplary Embodiment

1-1. Overall Configuration of Information Processing Apparatus

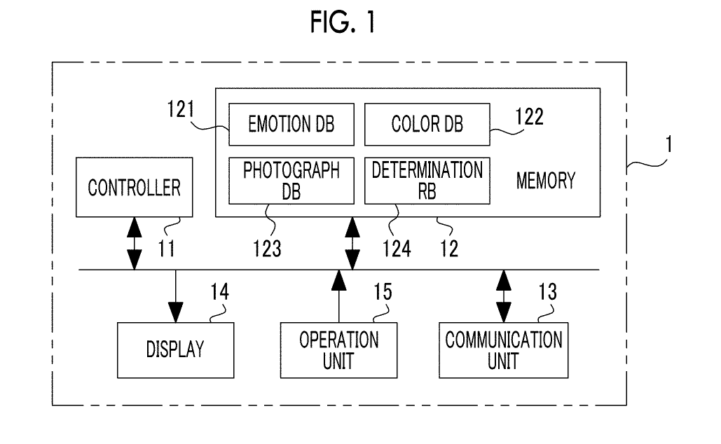

FIG. 1 is a diagram illustrating a configuration of an information processing apparatus 1 according to an exemplary embodiment. The information processing apparatus 1 includes a controller 11, a memory 12, a communication unit 13, a display 14, and an operation unit 15.

For example, in order to promote sales of goods and services, printed matters such as posters, stickers, and pamphlets are produced using images such as photographs and illustrations related to the sale object. Further, in addition to printed matters, display matters such as net advertisements and television advertisements are sometimes produced using images expressing the above-mentioned goods.

Further, even in a case where it is not intended to promote sales, when there is, for example, information to convey, such as public advertisements, opinion advertisements, and government information, printed matters and display matters are produced using images such as photographs and illustrations. The printed matters and displayed matters are called promotional objects or the like. The information processing apparatus 1 is adapted to specify the color scheme to be applied to the image used for the above-mentioned promotional objects or the like.

A color scheme is to match two or more colors. Two or more types of colors constituting the color scheme are called constituent colors.

The controller 11 includes a central processing unit (CPU), a read only memory (ROM), and a random access memory (RAM), and the CPU reads out and executes the computer program (hereinafter referred to simply as “program”) stored in the ROM and the memory 12 to control each part of the information processing apparatus 1.

The communication unit 13 is a communication circuit which is connected to a communication line such as the Internet by wireless or wired. The information processing apparatus 1 exchanges information with various devices connected to the communication line by the communication unit 13. Note that the information processing apparatus 1 may not have the communication unit 13.

The operation unit 15 is equipped with operators such as operation buttons for giving various instructions and a keyboard, receives an operation by a user, and supplies a signal corresponding to the operation contents to the controller 11. The operation unit 15 may include a touch panel for detecting an operator such as a user's finger or a stylus pen. The operation unit 15 may have a microphone that records the user's voice and converting the voice into a voice signal and a voice operation mechanism that generates a control signal by recognizing the content of the voice from the voice signal. For example, in a case where the controller 11 receives various instructions from the user from an external terminal through the communication unit 13, the information processing apparatus 1 may not have the operation unit 15.

The display 14 includes a display screen such as a liquid crystal display, and displays an image under the control of the controller 11. A transparent touch panel of the operation unit 15 may be disposed so as to be superimposed on the display screen. In a case where it is possible to allow the user to generate an image by applying the color scheme specified by the controller 11 without using the display 14, the information processing apparatus 1 may not include the display 14.

The memory 12 is a large-capacity storage unit such as a solid state drive and a hard disk drive, and stores various programs which are read into the CPU of the controller 11. Further, the memory 12 stores an emotion DB 121, a color DB 122, a photograph DB 123, and a determination RB 124.

The emotion DB 121 is a database that stores a color scheme and emotion to be associated with the color scheme in correspondence with each other. The color DB 122 is a database storing the gradation value of a color and the hue and tone to which the color belongs in correspondence with each other. The photograph DB 123 is a database storing image data representing photographs. The determination RB 124 is a rule base defining rules such as a commonality and a readability for a color.

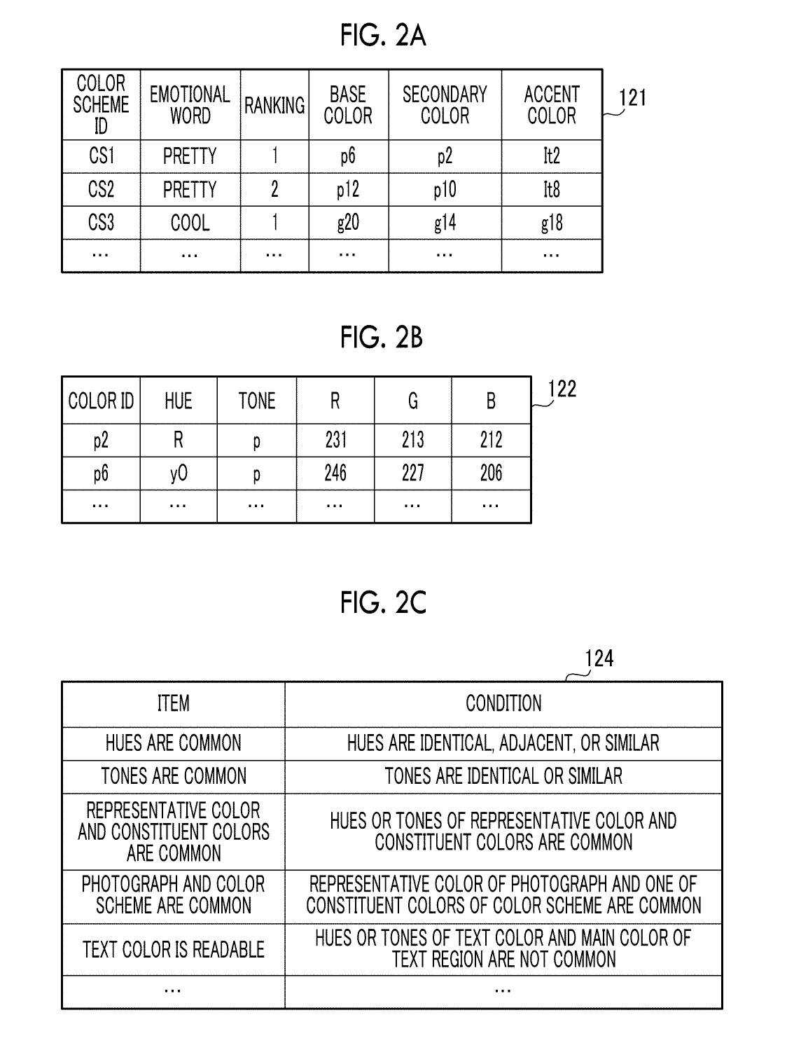

FIGS. 2A to 2C are diagrams illustrating various databases and a rule base stored in the memory 12. The emotion DB 121 illustrated in FIG. 2A has a color scheme ID for identifying a color scheme, a color ID which is identification information of each of constituent colors constituting the color scheme, a word indicating emotion (hereinafter, referred to as “emotional word”), and a ranking indicating the ease of association from the color scheme with respect to the emotion indicated by the emotional word in correspondence with each other.

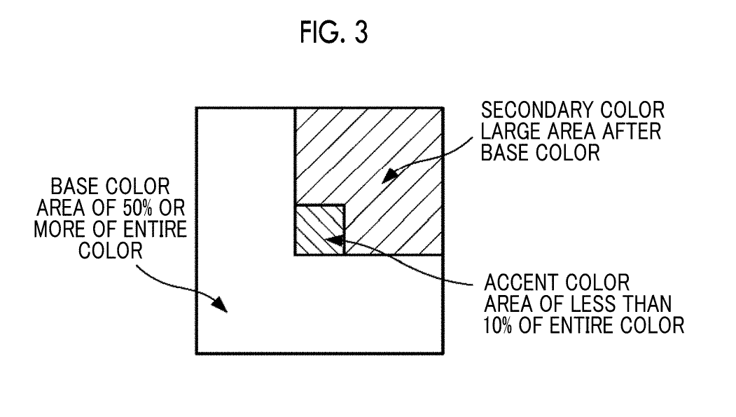

FIG. 3 is a view for explaining types of constituent colors constituting a color scheme. The type of each of the two or more constituent colors constituting the color scheme is determined respectively. This type is determined, for example, by the ratio of the area where the constituent color is used to the total area in the image to which the color scheme is applied.

For example, in the example illustrated in FIG. 3, a color scheme is configured with three constituent colors, and the types of constituent colors are a base color, a secondary color, and an accent color. In the following description, the base color, the secondary color, and the accent color are sometimes described as “base”, “secondary”, and “accent”, respectively.

The base color is, for example, a color having an area of 50% or more of the entire color in the color scheme. The secondary color is a color having a large area after the base color. The accent color is a color having an area of less than 10% of the entire color. The color scheme may be configured with two constituent colors or four or more constituent colors. Further, the area ratio of the constituent colors constituting the color scheme to the whole is not limited to the above-mentioned one.

In the emotion DB 121 illustrated in FIG. 2A, for example, the color scheme identified by the color scheme ID “CS1” is such that the base color identification information is “p6”, the secondary color identification information is “p2”, and the accent color identification information is “lt2”. Further, the color scheme has the No. 1 ranking showing the ease of association with respect to the emotion indicated by the emotional word “pretty”.

For example, with respect to the ranking indicating the ease of association, each combination of a color scheme and an emotional word is shown to statistically reliable number of subjects, the subjects are asked whether they can associate the emotion indicated by the emotional word with the color scheme, and the answers are aggregated. The more the positive answers, the higher ranking the combination has. It should be noted that the ranking is not limited to those based on the above-mentioned aggregation as long as a combination of each color scheme and an emotional word is specified. This ranking may be determined by, for example, an editor of the emotion DB 121. In addition, in the emotion DB 121, rather than the ranking itself, but information corresponding to the ranking, such as the number of positive answers of the subject described above, may be associated with a combination of a color scheme and an emotional word.

Further, all the color schemes stored in the emotion DB 121 are configured with the constituent colors selected based on a predetermined method. These color schemes are configured with constituent colors selected based on various harmonic color scheme methods of similar harmony, contrast harmony, Camaieu harmony, Faux Camaieu harmony, and the like. Therefore, the color scheme stored in the emotion DB 121 is configured with the constituent colors satisfying the predetermined condition in the harmonic color scheme method described above.

The color DB 122 illustrated in FIG. 2B stores a color ID which is identification information for identifying a color, gradation values of red (R), green (G) and blue (B) obtained by decomposing the color into R, G and B which are three primary colors in additive mixing, the identification information of the hue to which the color belongs, and the identification information of the tone to which the color belongs in correspondence with each other. The hue and tone to which the color belongs are specified based on the color DB 122.

In the color DB 122 illustrated in FIG. 2B, the gradation values representing red (R), green (G), and blue (B) included in the color identified by the color ID “p2” with 8-bit gradations (that is, 256 gradations) are “231”, “213”, and “212”. Then, in the color identified by the color ID “p2”, the identification information representing the hue is “R” and the identification information representing the tone is “p”.

The determination RB 124 illustrated in FIG. 2C is a rule base used for the controller 11 to determine whether or not there is a commonality between the color scheme selected as a candidate and the representative color of a photograph. The determination RB 124 stores the item that is the object of the above determination in correspondence with the condition for determining the item.

For example, in the determination RB 124 illustrated in FIG. 2C, “hues are common” means that hues are the identical, adjacent, or similar, and “tones are common” means that tones are the identical or similar.

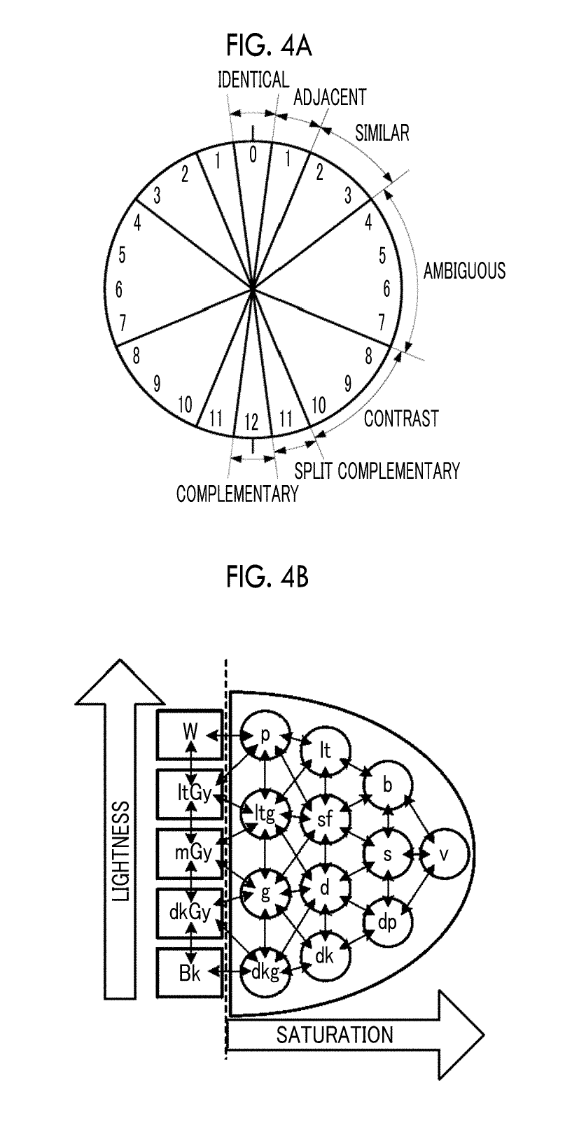

FIGS. 4A and 4B are diagrams for explaining hue and tone commonalities. The hue circle illustrated in FIG. 4A is a hue circle in the Practical Color Co-ordinate System (PCCS) developed by the Japan Color Research Institute, in which hues are classified into 24 types and arrayed circularly.

The numerals described in the hue circle illustrated in FIG. 4A indicate the distance from the hue (referred to as the reference hue) located in the upper part in FIG. 4A to each hue. For example, the hue with the number “0” has a distance of zero from the reference hue, and the relationship between the two hues is “identical”. Further, in a case where the number is “1”, the relationship between the two hues is “adjacent”. Further, in a case where the number is “2” or “3”, the relationship between the two hues is “similar”.

Then, in a case where the above-mentioned number is “4” or more and “7” or less, the relationship between the two hues is “ambiguous”, and in a case where the above-mentioned number is “8” or more and “10” or less, the relationship between the two hues is “contrast”. Further, in a case where the above-mentioned number is “12”, the relationship between the two hues is “complementary”, and in a case where the above-mentioned number is “11”, the relationship between the two hues is “split complementary”.

A tone map illustrated in FIG. 4B is a tone map in the above-mentioned PCCS, in which the tones to which colors belong are classified and disposed in five types for achromatic colors and 12 types for chromatic colors. Tone is a compound concept of lightness and saturation.

In FIG. 4B, tones are arranged such that the brightness increases (that is, the lightness increases) as it goes up in the vertical direction and the color is richer (that is, the saturation increases) as it goes right in the left-right direction.

The five types of tones of achromatic colors are white (W), light gray (ltGy), medium gray (mGy), dark gray (dkGy), and black (Bk), and the tones connected by the lines illustrated in FIG. 4B among them are in a similar relationship. For example, the relationship between white (W) and light gray (ltGy) is similar.

With respect to the 12 types of tones of chromatic colors, the tones connected by the lines illustrated in FIG. 4B are in a similar relationship. For example, the relationship between light (lt) and soft (sf) is similar. Further, four types of low saturation: pale (p), light grayish (ltg), grayish (g), and dark grayish (dkg) among the 12 types of tones of chromatic colors are in a similar relationship with achromatic tones. For example, light grayish (ltg) of a chromatic color is in a similar relationship with a light gray (ltGy) and a medium gray (mGy) which are achromatic colors, respectively.

It is to be noted that, among the five types of achromatic colors and the twelve types of chromatic colors, the relationship between two different types of tones which are not connected by the above-described line is not the identical or similar, so it is “dissimilar”. Identification information in PCCS are used for color ID in following samples.

1-2. Functional Configuration of Information Processing Apparatus

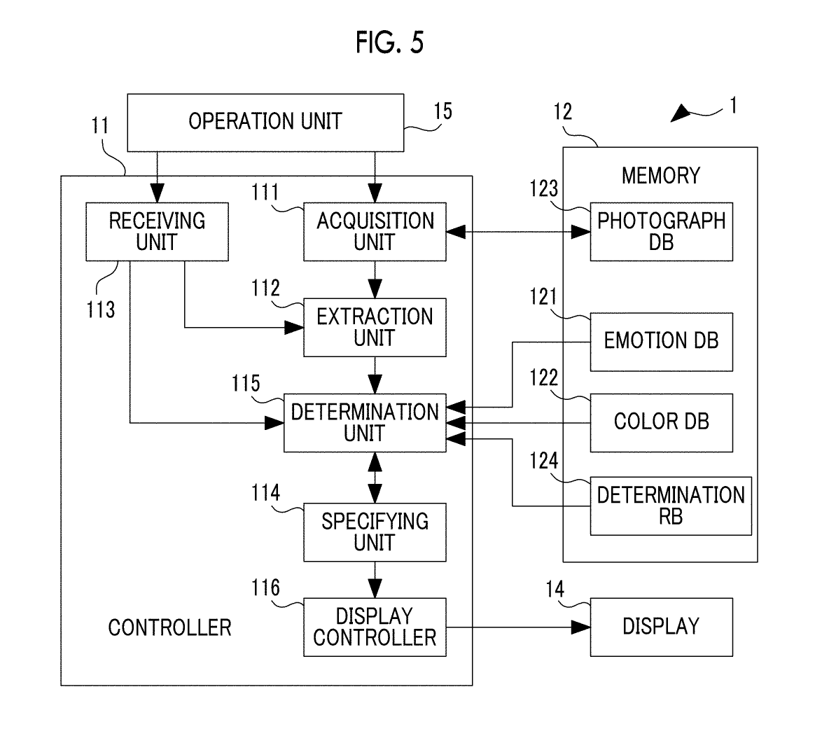

FIG. 5 is a diagram illustrating a functional configuration of the information processing apparatus 1. The controller 11 of the information processing apparatus 1 illustrated in FIG. 5 executes the program stored in the memory 12 illustrated in FIG. 1 to function as an acquisition unit 111, an extraction unit 112, a receiving unit 113, a specifying unit 114, a determination unit 115, and a display controller 116.

The acquisition unit 111 acquires an image. For example, as illustrated in FIG. 5, the acquisition unit 111 acquires an image such as a photograph in response to an operation on the operation unit 15 by the user. The acquisition unit 111 may acquire an image from a device connected to the communication circuit through the communication unit 13 illustrated in FIG. 1, for example, in response to the above-described operation. Further, the acquisition unit 111 may acquire an image from the photograph DB 123 stored in the memory 12 in response to the above-described operation, and may store the acquired image in the photograph DB 123.

The extraction unit 112 extracts a representative color of the image from the image acquired by the acquisition unit 111. The representative color is a color representative of an image, and for example, a color determined from the mode calculated by aggregating the gradation values of pixels constituting the image.

The receiving unit 113 receives the designated “emotional word” which is a word expressing emotion, by the user operating the operation unit 15. In a case where the user designates an emotional word by, for example, filling in an emotional word with a keyboard, a touch panel or the like included in the operation unit 15 or by speaking an emotional word towards a microphone, the operation unit 15 transmits a control signal corresponding to the emotional word to the controller 11. The receiving unit 113 realized by the controller 11 receives the designated emotional word by receiving the control signal sent from the operation unit 15.

The determination unit 115 determines whether or not the color scheme of interest corresponds to the emotion indicated by the emotional word and whether or not the color scheme of interest is common to the representative color extracted by the extraction unit 112. For example, the determination unit 115 illustrated in FIG. 5 first refers to the color DB 122 and specifies the hue and tone of the representative color extracted by the extraction unit 112.

Then, the determination unit 115 extracts a candidate for the color scheme that satisfies the determined condition, such as the color scheme having the ranking of the emotional word received by the receiving unit 113 from the emotion DB 121 of, for example, the third place or more, as a color scheme candidate corresponding to the emotional word, hereinafter, referred to as “color scheme candidate”). The determination unit 115 specifies the hue and tone of each of the constituent colors (one of the base color, the secondary color, and the accent color in the above-described example) constituting the extracted color scheme candidate by referring to the color DB 122. Then, the determination unit 115 refers to the determination RB 124 and determines whether or not the hue and tone of one of the constituent colors constituting the color scheme candidate corresponding to the emotional word and the hue and tone of the representative color are common.

The specifying unit 114 exchanges with the determination unit 115, and specifies a color scheme to be applied to an image which is generated by a user, by using the emotional word and the representative color. In the display including the image acquired by the acquisition unit 111, in a case where there is a color scheme having a constituent color corresponding to the emotion indicated by the emotional word and common to the representative color, the specifying unit 114 illustrated in FIG. 5 specifies the color scheme.

Note that the receiving unit 113 illustrated in FIG. 5 may receive a designated region where text is disposed. In this case, the specifying unit 114 illustrated in FIG. 5 specifies a color of a text (also referred to as a text color) satisfying a condition regarding readability (hereinafter referred to as “first condition”) with respect to a color of the designated region (also referred to as region color). The first condition is described in the determination RB 124 and is, for example, a condition that the hues and tones of the text color and the region color are not common.

Further, in a case where the designated region is included in the image acquired by the acquisition unit 111, the extraction unit 112 illustrated in FIG. 5 extracts a region representative color which is a color representative of the above-described region. Then, the specifying unit 114 specifies the color of the text that satisfies the first condition with respect to the region representative color extracted by the extraction unit 112.

The above-described specifying unit 114 specifies the color scheme to be applied to the image generated by the user by exchanging with the determination unit 115. However, for example, the determination unit 115 may specify the color scheme candidate as “color scheme applied to the image generated by the user”, in a case where it is determined that the hue and tone of the color scheme candidate corresponding to the emotional word and the hue and tone of the representative color are common. In this case, “the hue and tone of the color scheme candidate corresponding to the emotional word are common to the hue and tone of the representative color” means that an example of a condition regarding a commonality with a representative color (hereinafter, referred to as “second condition”).

That is, in a case where there is a color scheme (hereinafter, referred to as a first color scheme) corresponding to the emotion indicated by the emotional word and satisfying a second condition regarding commonality with the representative color extracted by the extraction unit 112 in the display including the image acquired by the acquisition unit 111, the specifying unit 114 specifies the first color scheme.

The display controller 116 controls the display 14 to notify the user of the color scheme specified by the specifying unit 114. The display controller 116 may control the display 14 to display an image to which the color scheme specified by the specifying unit 114 is applied.

1-3. Operation of Information Processing Apparatus

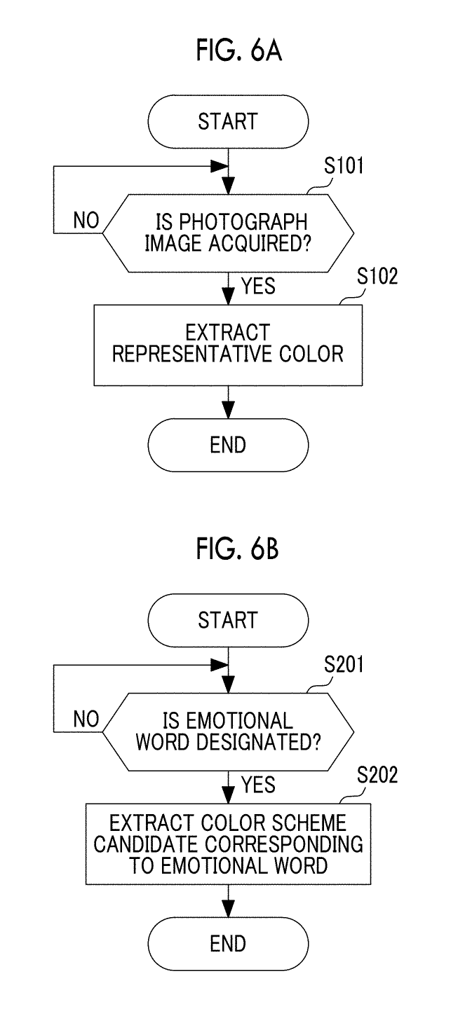

FIGS. 6A and 6B are flowcharts illustrating a flow of an operation of extracting a representative color and a color scheme candidate of the information processing apparatus 1. According to the flowchart illustrated in FIG. 6A, the controller 11 of the information processing apparatus 1 determines whether or not an image such as a photograph has been acquired (step S101). While determining that an image has not been acquired (step S101; NO), this determination is continued. In a case of determining that the image has been acquired (step S101; YES), the controller 11 extracts a representative color from the acquired image (step S102). In step S102, the controller 11 may specify the hue and tone of the extracted representative color.

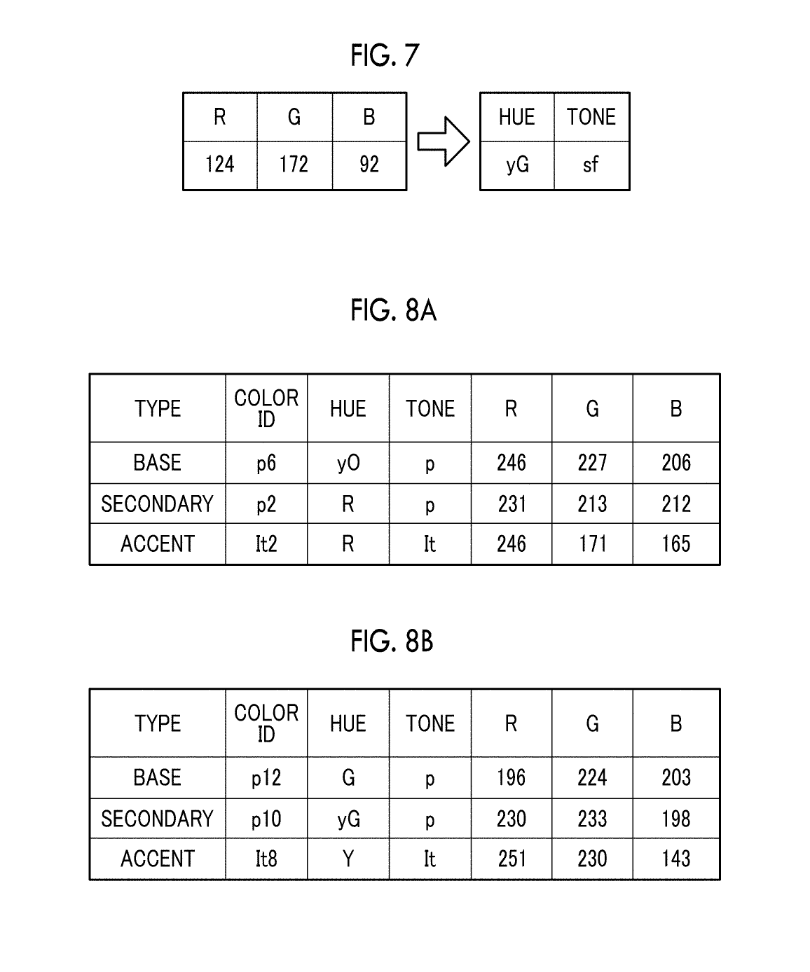

FIG. 7 is a view illustrating an example of a hue and a tone specified from gradation values of the representative color. As illustrated in FIG. 7, in a case where the gradation values of red (R), green (G), and blue (B) of the representative color are “124”, “172”, and “92”, the controller 11 specifies the hue and tone of the representative color as “yG” and “sf” by referring to the determined correspondence table or the like.

According to the flowchart illustrated in FIG. 6B, the controller 11 of the information processing apparatus 1 determines whether or not a designated emotional word has been received (step S201). While determining that the designated word has not been received (step S201; NO), this determination is continued. In a case of determining that a designated emotional word has been received (step S201; YES), the controller 11 extracts a color scheme candidate corresponding to the designated emotional word from the emotion DB 121 (step S202). Further, in step S202, the controller 11 may specify the hue and the tone by referring to the color DB 122 for each constituent color of the extracted color scheme candidate.

FIGS. 8A and 8B are diagrams illustrating examples of hues and tones specified from each constituent color of a color scheme candidate. For example, in a case of receiving a designated emotional word “pretty” from the user, the controller 11 refers to the emotion DB 121 illustrated in FIG. 2A and specifies the color scheme ID “CS1” of ranking “1” for “pretty” and the color scheme ID “CS2” of ranking “2”, respectively.

Then, the controller 11 specifies the hues and tones corresponding to the base color “p6”, the secondary color “p2” and the accent color “lt2” of the color scheme ID “CS1”, and the hues and tones corresponding to the base color “p12”, the secondary color “p10” and the accent color “lt8” of the color scheme ID “CS2”, respectively, with reference to the color DB 122 illustrated in FIG. 2B.

FIG. 8A illustrates the hue and tone of each color constituting the color scheme candidate indicated by the color scheme ID “CS1”. The color scheme candidate indicated by the color scheme ID “CS1” is specified that the hue and tone of the base color “p6” are “yO” and “p”, the hue and tone of the secondary color “p2” are “R” and “p”, and the hue and tone of the accent color “lt2” are “R” and “lt”.

FIG. 8B illustrates the hue and tone of each color constituting the color scheme candidate indicated by the color scheme ID “CS2”. The color scheme candidate indicated by the color scheme ID “CS2” is specified that the hue and tone of the base color “p12” are “G” and “p”, the hue and tone of the secondary color “p10” are “yG” and “p”, and the hue and tone of the accent color “lt8” are “Y” and “lt”.

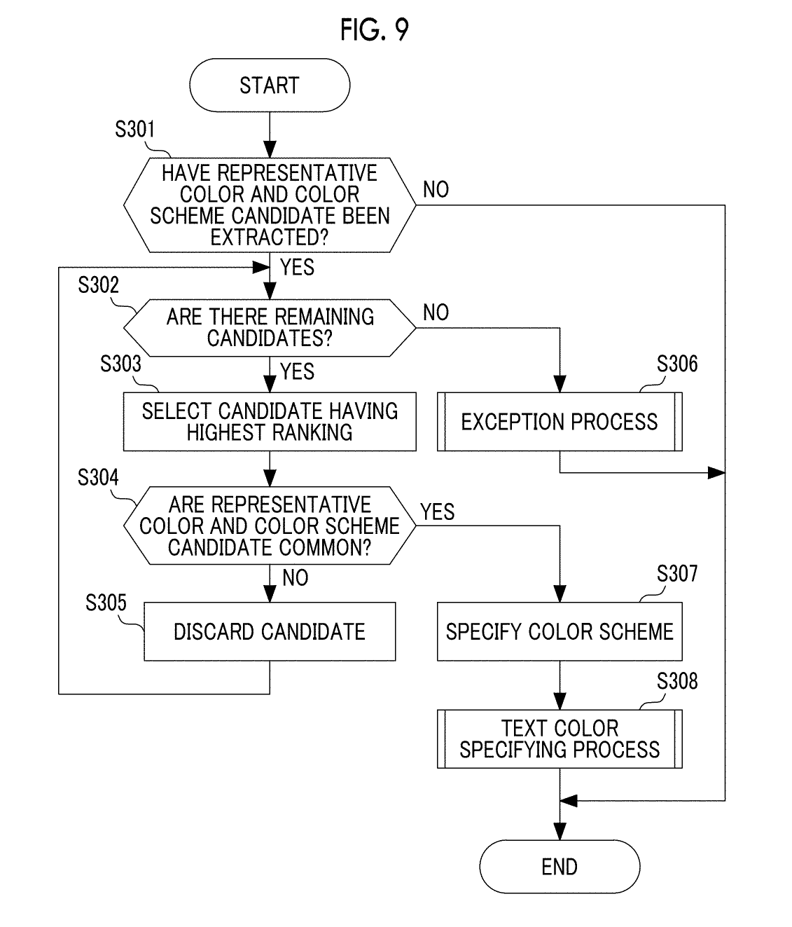

FIG. 9 is a flowchart illustrating a flow of an operation for specifying a color scheme of the information processing apparatus 1. According to the flowchart illustrated in FIG. 9, the controller 11 of the information processing apparatus 1 determines whether or not the representative color and the color scheme candidate have already been extracted (step S301), and determines whether at least one of the representative color or the color scheme candidate has not been extracted (step S301; NO), and the process is terminated.

On the other hand, in a case where it is determined that both the representative color and the color scheme candidate have already been extracted (step S301; YES), the controller 11 determines whether or not there are remaining color scheme candidates (step S302), and in a case where it is determined that there are no remaining color scheme candidates (step S302; NO), an exception process is executed (step S306), and the process is terminated.

Various exception processes can be adopted, and for example, the exception process may be a process of notifying the user that there is no color scheme which corresponds to the designated emotional word and is common to the representative color extracted from the acquired image.

In a case where it is determined that there are remaining color scheme candidates (step S302; YES), the controller 11 selects a color scheme candidate having the highest ranking among the remaining color scheme candidates (step S303). The controller 11 determines whether or not the extracted representative color and the selected color scheme candidate are common (step S304). In a case where it is determined that they are not common (step S304; NO), the controller 11 discards the color scheme candidate (step S305), and returns the process to step S302.

On the other hand, in a case where it is determined that the extracted representative color and the selected color scheme candidate are common (step S304; YES), the controller 11 specifies the color scheme of the color scheme candidate (step S307), performs a text color specifying process which is a process of specifying the text color (step S308), and ends the process.

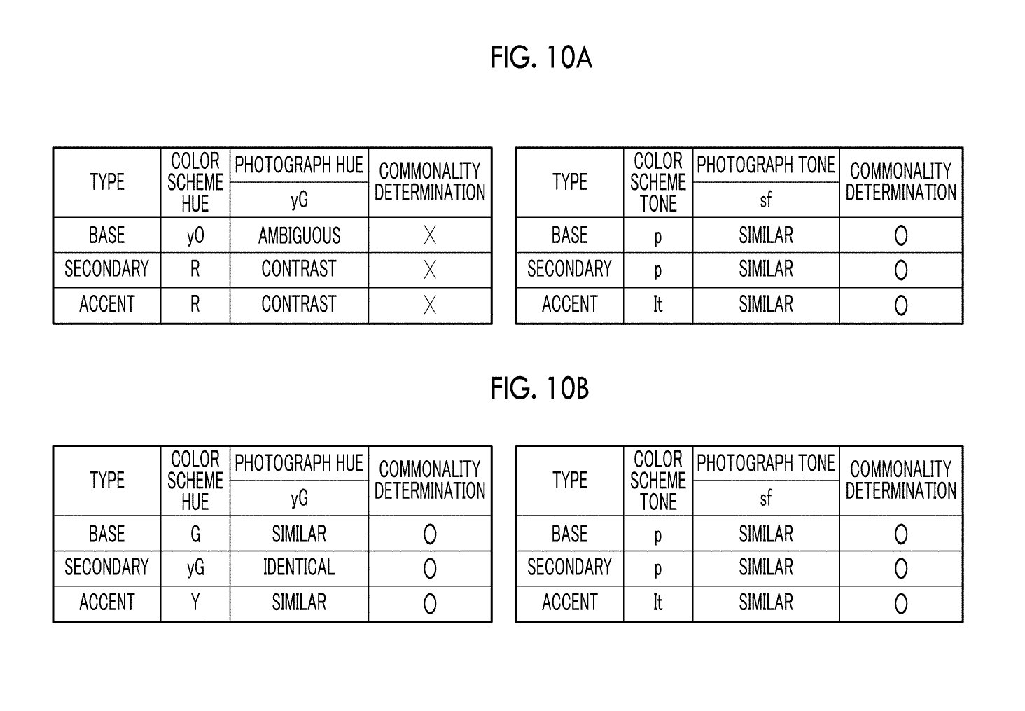

FIGS. 10A and 10B are diagrams illustrating an example of determining a commonality between a representative color and a color scheme candidate. The determination illustrated in FIG. 10A is as to determination of the commonality between the representative color illustrated in FIG. 7 and the color scheme candidate of the color scheme ID “CS1” illustrated in FIG. 8A.

Since the tone “p” of the base color and the secondary color at the color scheme ID “CS1” and the tone “sf” of the representative color of the photograph are in a similar relationship, the commonality determination result is “common”. In addition, since the tone “lt” of the accent color at the color scheme ID “CS1” and the tone “sf” of the representative color of the photograph are in a similar relationship, the commonality determination result is “common”. Therefore, the result of determination on a commonality of the tones of each color of the color scheme candidate identified by the color scheme ID “CS1” and the representative color of the photograph is “O” indicating that they are common.

On the other hand, since the hue “yO” of the base color at the color scheme ID “CS1” and the hue “yG” of the representative color of the photograph are in a medium difference relationship, they are not common. Since the hue “R” of the secondary color and the accent color at the color scheme ID “CS1” and the hue “yG” of the representative color of the photograph are in a contrast relationship, they are not common. Therefore, the result of determination on a commonality of the hues of each color of the color scheme candidate identified by the color scheme ID “CS1” and the representative color of the photograph is “X” indicating that they are not common.

As illustrated in FIG. 2C, the commonality condition between the photograph and the color scheme is “that the representative color of the photograph and one of the constituent colors of the color scheme are common”. That is, in a case where any one of the constituent colors constituting the color scheme and the representative color of the photograph are common, it is determined that the photograph and the color scheme are common.

Then, the commonality condition between the representative color and the constituent color is “that the hues and tones of the representative color and the constituent color are common”. That is, with respect to the representative color of a photograph and one constituent color, unless both the hues and tones are common, they are not determined to be common.

With respect to the above-described color scheme ID “CS1”, the tone of the base color, the secondary color, or the accent color is common to that of the representative color of the photograph, but the hue is not common to that of the representative color of the photograph. Therefore, since the representative color of the photograph is not common to the color scheme identified by the color scheme ID “CS1”, the controller 11 discards the color scheme candidate and determines the commonality for the next color scheme candidate.

The determination illustrated in FIG. 10B is determination of the commonality between the representative color illustrated in FIG. 7 and the color scheme candidate of the color scheme ID “CS2” illustrated in FIG. 8B.

Since the tone “p” of the base color and the secondary color at the color scheme ID “CS2” and the tone “sf” of the representative color of the photograph are in a similar relationship, the commonality determination result is “common”. In addition, since the tone “lt” of the accent color at the color scheme ID “CS2” and the tone “sf” of the representative color of the photograph are in a similar relationship, the commonality determination result is “common”. Therefore, the result of determination on a commonality of the tones of each color of the color scheme candidate identified by the color scheme ID “CS2” and the representative color of the photograph is “O” indicating that they are common.

Since the hue “G” of the base color at the color scheme ID “CS2” and the hue “yG” of the representative color of the photograph are in a similar relationship, they are common. Since the hue “yG” of the secondary color at the color scheme ID “CS2” and the hue “yG” of the representative color of the photograph are in the same relationship, they are common. Since the hue “Y” of the accent color at the color scheme ID “CS2” and the hue “yG” of the representative color of the photograph are in a similar relationship, they are common. Therefore, the result of determination on a commonality of the hues of each color of the color scheme candidate identified by the color scheme ID “CS2” and the representative color of the photograph is “O” indicating that they are common.

With respect to the above-described color scheme ID “CS2”, one of the base color, the secondary color, and the accent color is common to the representative color of the photograph in both hues and tones, so that the representative color of the photograph and the color scheme ID identified the color scheme “CS2” are common. Thus, the controller 11 specifies the color scheme of the color scheme candidate.

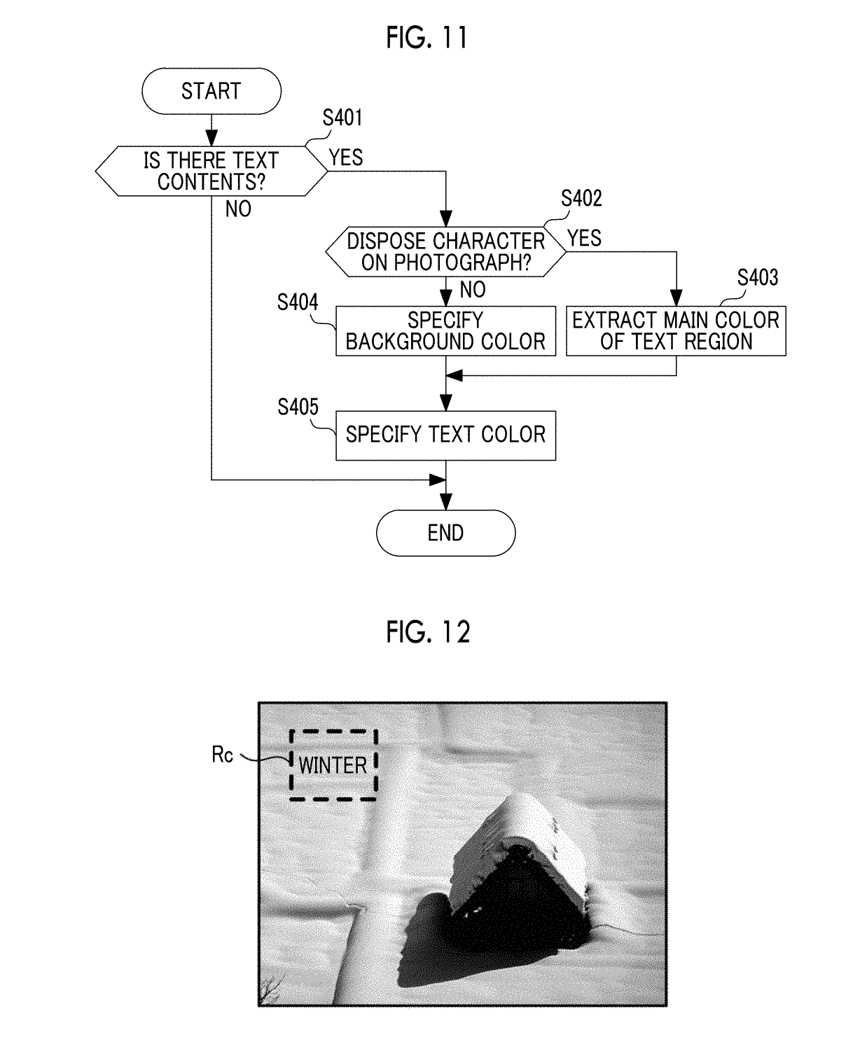

FIG. 11 is a flowchart illustrating a flow of an operation of a text color specifying process of the information processing apparatus 1. The controller 11 determines whether or not there is a text in the image generated by the user (step S401). In a case of determining that there is no text in the image (step S401; NO), the controller 11 terminates the process.

On the other hand, in a case of determining that there is a text in the image generated by the user (step S401; YES), the controller 11 determines whether or not the text is disposed on the image such as the acquired photograph (step S402).

In the case where it is determined that the text is disposed on the image such as a photograph (step S402; YES), the controller 11 extracts the region color which is the color of the region where the text is disposed in the image such as a photograph (step S403).

In the case where it is determined that the text is not disposed on the image such as a photograph (step S402; NO), the controller 11 specifies, for example, the base color as the background color in the specified color scheme (step S404).

The controller 11 specifies a text color having a readability, for the region color specified in step S403 or the background color specified in step S404 (step S405).

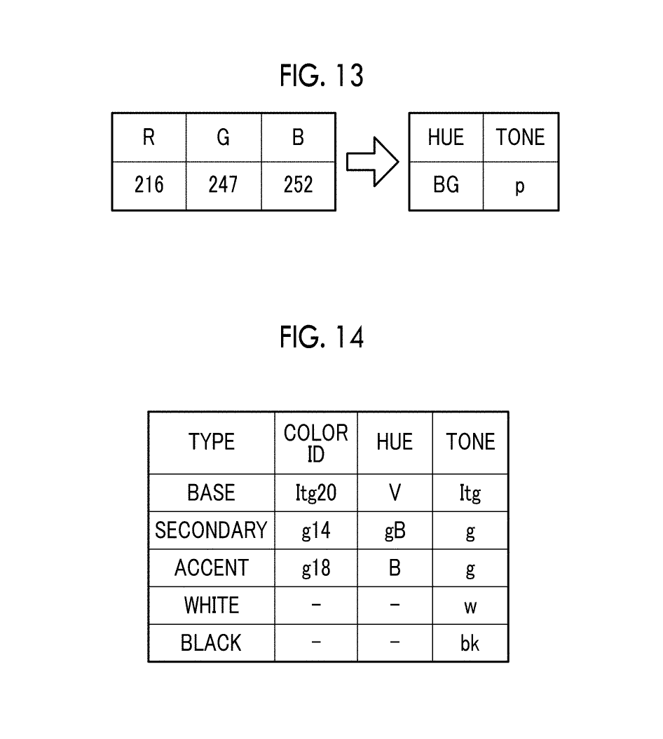

FIG. 12 is a diagram for explaining a region where text is disposed in a photograph. In the example illustrated in FIG. 12, the word “winter” is disposed in the upper left region Rc of the photograph. FIG. 13 is a view illustrating an example of a hue and a tone specified from gradation values of the representative color of a region where text is disposed in a photograph. For example, in a case of receiving a designated region Rc illustrated in FIG. 12 as a designated region where text is disposed, the controller 11 extracts a representative color of the region Rc separately from the representative color of the photograph. The representative color is the mode calculated by aggregating the gradation values of all the pixels included in the region Rc, for example.

As illustrated in FIG. 13, in a case where the gradation values of red (R), green (G), and blue (B) of the representative color of the region where text is disposed are “216”, “247”, and “252”, the controller 11 specifies the hue and tone of the representative color as “BG” and “p” by referring to the determined correspondence table or the like.

FIG. 14 is a diagram for explaining text color candidates based on a specified color scheme. Based on the color scheme specified in the above-described step S307, the controller 11 specifies a text color candidate. In the following example, the controller 11 specifies white and black as text color candidates in addition to the color scheme specified in step S307.

In the example illustrated in FIG. 14, the color ID, hue and tone of the base color are “ltg20”, “V” and “ltg”, the color ID, hue and tone of the secondary color are “g14”, “gB”, and “g”, and the color ID, hue and tone of the accent color are “g18”, “B”, and “g”. In addition to these three types of constituent colors, white and black are added as text color candidates. Since there is no hue defined for white and black, only tones are specified for white and black. As illustrated in FIG. 14, the white tone is “w” and the black tone is “bk”.

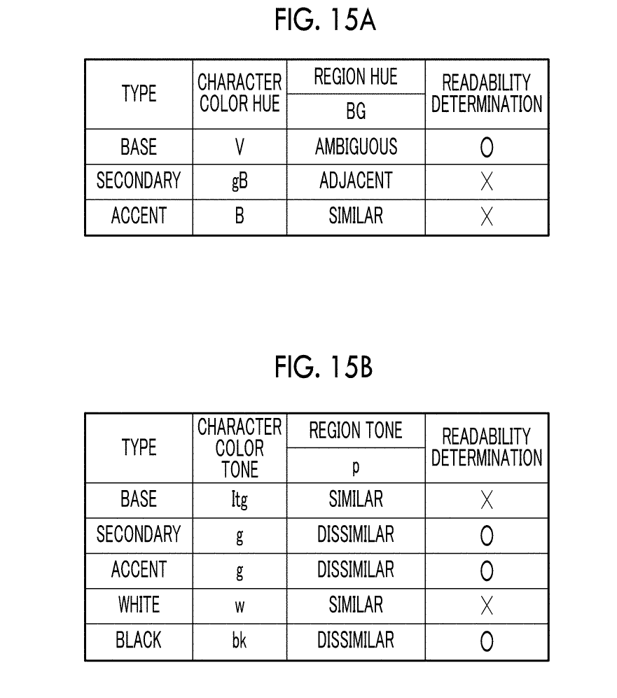

FIGS. 15A and 15B are diagrams illustrating an example of determining readability of a representative color and a text color candidate of a region on a photograph on which text is disposed. As illustrated in FIG. 15A, for the hue, three types of text colors except black and white are determined among five text color candidates. Since the hue “V” of the base color and the hue “BG” of the region color are in a medium difference relationship and are not common, the result of the readability determination in the hue of the base color is “O” indicating that the color has readability.

On the other hand, the hue “gB” of the secondary color and the hue “B” of the accent color are in an adjacent or similar relationship with the hue “BG” of the region color and are common. Therefore, the result of the readability determination as to the hues of the secondary color and the accent color is “X” indicating that the colors do not have readability.

Further, since the tones “g” of the secondary color and the accent color are in a dissimilar relationship with the tone “p” of the region color, the result of the readability determination as to the tones of the secondary color and the accent color is “O” indicating that the colors have readability.

Since the black tone “bk” is also in a dissimilar relationship with the tone “p” of the region color, the result of the readability determination as to the black tone is also “O” indicating that the black tone has readability.

On the other hand, since the tone “ltg” of the base color and the tone “p” of the region color are in a similar relationship and are common, the result of the readability determination as to the tone of the base color is “X” indicating that it does not have readability.

Since the while tone “w” and the tone “p” of the region color are in a similar relationship and are common, the result of the readability determination as to the white tone is “X” indicating that it does not have readability.

As illustrated in FIG. 2C, the condition that the text color is readable means “either one of hue and tone of text color is not common to that of the region color”. Therefore, in the example illustrated in FIGS. 15A and 15B, since the hue of the base color is not common and the tones of the secondary color and the accent color are not common, these three types of constituent colors are readable as text colors and can be adopted.

On the other hand, since white is common to region colors in tones rather than hues, white has no readability as a text color. Therefore, white is not adopted as text color. Black has readability since it is not common to region colors in tone and can be adopted as a text color.

By the above operation, in a case where the user generates images such as promotional objects that match the emotion designated using the acquired images, the color scheme to be applied is specified.

### 2. Modification Example

The above is an explanation of an exemplary embodiment, but the contents of the exemplary embodiment can be modified as follows. In addition, the following modification examples may be combined.

### 2-1. Modification Example 1

In the exemplary embodiment described above, the receiving unit 113 receives a designated region where text is disposed, but it may not be designated. In this case, in a case where the color scheme is specified, the information processing apparatus 1 may not specify the text color.

### 2-2. Modification Example 2

In the exemplary embodiment described above, in a case where the designated region is included in the acquired image, the extraction unit 112 extracts the region representative color which is a color representative of the region, but may not extract the region representative color. For example, the information processing apparatus 1 may receive a designated region and a designated representative color of the region. Further, the user may check the designated region and select the color of the text to be disposed on the region.

### 2-3. Modification Example 3

In the exemplary embodiment described above, in a case where there is a first color scheme corresponding to the emotion indicated by the emotional word and satisfying the second condition regarding the commonality with a representative color extracted by the extraction unit 112 in the display including the image acquired by the acquisition unit 111, the specifying unit 114 specifies the first color scheme, but the invention is not limited thereto, and a color scheme to be applied to the image generated by the user may be specified by using the designated emotional word and the extracted representative color.

### 2-4. Modification Example 4

In the exemplary embodiment described above, in a case where it is determined that there is no remaining color scheme candidate in the determination of step S302, that is, in a case where there is no above-described first color scheme, the controller 11 of the information processing apparatus 1 performs an exception process of step S306.

Here, the exception process of the exemplary embodiment described above is a process of notifying the user that there is no color scheme which corresponds to the designated emotional word and is common to the representative color extracted from the acquired image, but the exception process may be a process of specifying another color scheme. For example, in a case where there is no above-described first color scheme, the specifying unit 114 may specify a second color scheme that satisfies the second condition with respect to a representative color extracted by the extraction unit 112, and an emotional word indicating the emotion corresponding to the second color scheme.

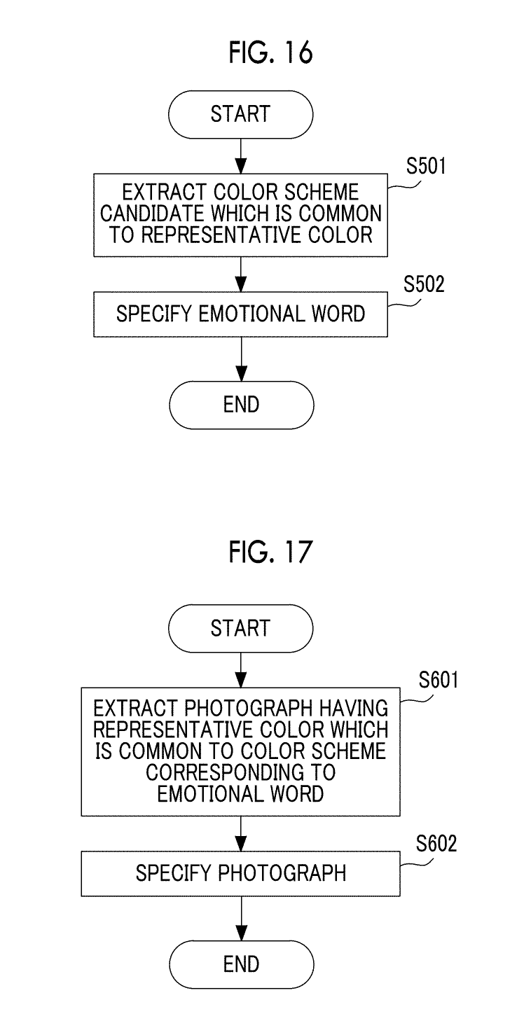

FIG. 16 is a flowchart illustrating a flow of an operation for specifying a color scheme of the information processing apparatus 1 in Modification Example 4. In a case where it is determined that there is no remaining color scheme candidate corresponding to the emotion indicated by the emotional word in step S302, the controller 11 extracts a color scheme candidate (second color scheme) which is common to the extracted representative color (step S501). Then, the controller 11 may specify the emotional word corresponding to the extracted color scheme candidate (step S502).

The user may be notified of the newly extracted color scheme candidate and the specified emotional word. By this notification, in a case of using the image acquired by the information processing apparatus 1, the user knows that there is no color scheme for generating an image corresponding to the emotion indicated by the designated emotional word.

Then, in a case where it is determined that an image corresponding to the emotion indicated by the emotional word notified by the information processing apparatus 1, which is an emotional word different from the emotional word designated by the user, may be generated, the user may issue an instruction to adopt a notified new color scheme candidate.

### 2-5. Modification Example 5

Further, in a case where there is no above-described first color scheme, the specifying unit 114 may specify a third color scheme corresponding to the emotion indicated by the designated emotional word, and an image which is different from the image acquired by the acquisition unit 111 and of which representative color satisfies the second condition.

FIG. 17 is a flowchart illustrating a flow of an operation for specifying a color scheme of the information processing apparatus 1 in Modification Example 5. In a case where it is determined that there is no remaining color scheme candidate corresponding to the emotion indicated by the emotional word in step S302, the controller 11 extracts a color scheme candidate (third color scheme) corresponding to the emotional word, and extracts a photograph having a representative color common to the color scheme candidate from the photograph DB 123 (step S601). Then, the controller 11 may specify the extracted photograph (step S602).

The user may be notified of the newly extracted color scheme candidate and the specified photograph. By this notification, in a case of using the image acquired by the information processing apparatus 1, the user knows that there is no color scheme for generating an image corresponding to the emotion indicated by the designated emotional word.

Then, in a case where it is determined that a photograph which is notified by the information processing apparatus 1 and is different from the photograph that the user has acquired by the information processing apparatus 1 may be adopted, the user may give instructions of adopting a notified new color scheme candidate and a photograph.

### 2-6. Modification Example 6

In the exemplary embodiment described above, the information processing apparatus 1 specifies the color scheme to be applied to the image generated by the user. However, in addition to the color scheme, the information processing apparatus 1 may specify layout information to be applied to an image such as a promotional object generated by applying the color scheme. The layout information is the information indicating the conditions of the constituent elements constituting the image, such as the position or frame of the photograph or illustration in the image, and in a case where a text is included, the type (font), size (font size), arrangement, reference line and the like of the text, or the conditions of arrangement (layout) of the constituent elements.

For example, the layout information may be stored in correspondence with each color scheme ID in the emotion DB 121. Further, the layout information may be stored in a database associated with the emotional word.

For example, a relatively large font size of 36 points or more may be described as layout information for the emotional word “energetic” representing strength, and a font such as “Round Gothic body” having a rounded font may be described as layout information for the emotional word “pretty”. Further, in the emotional word “energetic”, a layout in which text to be displayed are disposed so as to protrude from the end portion of the paper may be described as layout information.

With this configuration, in a case where the information processing apparatus 1 specifies a color scheme or an emotional word, it also specifies the layout information associated with the color scheme or the emotional word.

### 2-7. Modification Example 7

The program executed by the controller 11 of the information processing apparatus 1 can be provided by being stored in a computer readable recording medium such as a magnetic recording medium such as a magnetic tape and a magnetic disk, an optical recording medium such as an optical disk, a magneto-optical recording medium, and a semiconductor memory. It is also possible to download the program through a communication line such as the Internet. As a control unit exemplified by the above-described controller 11, various devices other than the CPU may be applied, for example, a dedicated processor or the like is used.

### 2-8. Modification Example 8

The readability determination as to the combination of the text color and the background color (or region color) may be performed using data (referred to as “readability determination data”) obtained by aggregating human evaluations. In this case, for example, in the readability determination, the readability is classified into six stages of “1=very difficult to read, 2=rather difficult to read, 3=somewhat difficult to read, 4=read normally, 5=easy to read, and 6=very easy to read”, and plural persons visually evaluates the readability for each combination of text color and background color or region color. Then, the results of the evaluation are aggregated and the arithmetic mean value is stored in the memory 12 as readability determination data. The controller 11 reads out the readability determination data from the memory 12, determines that the combination whose numerical value indicated by the readability determination data is, for example, three or more is readable, and determines that the combination whose numerical value is less than 3 is difficult to read. In this example, a rule such as “Refer to readability determination data, and in a case where it is three or more, it is readable” may be described in the determination RB 124 illustrated in FIG. 2C.

### 2-9. Modification Example 9

The information processing apparatus 1 may include a measuring unit that measures the area of the image acquired by the acquisition unit 111 and the area of the entire image. In this case, the controller 11 of the information processing apparatus 1 calculates the ratio of the area of the acquired image to the area of the whole image, and when the calculated ratio satisfies the determined condition, the specification of the color scheme corresponding to the acquired image may be executed or prohibited.

For example, the controller 11 calculates the ratio of the area of the acquired image to the area of the whole image, and in the case where it is determined that the calculated ratio is equal to or smaller than the predetermined ratio, the controller 11 may not specify a color scheme depending on the acquired image. In addition, in a case where the number of pixels of the representative color of the image acquired by the acquisition unit 111 is equal to or smaller than a predetermined number or is equal to or smaller than the ratio determined for the total number of pixels, the controller 11 may not specify the color scheme depending on the acquired image.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an acquisition unit that acquires an image;
an extraction unit that extracts a representative color which is a color representative of the image acquired by the acquisition unit;
a receiving unit that receives a designated word indicating emotion; and
a specifying unit that specifies a color scheme to be applied to an image which is generated by a user, by using the word and the representative color.

2. The information processing apparatus according to claim 1,
wherein the receiving unit receives a designated region where a text is disposed, and
wherein the specifying unit specifies a color of the text satisfying a first condition regarding readability with respect to the color of the region.

3. The information processing apparatus according to claim 2,
wherein the extraction unit extracts a region representative color which is a color representative of the region, in a case where the region is included in the image acquired by the acquisition unit, and
wherein the specifying unit specifies a color of the text satisfying the first condition with respect to the region representative color.

4. The information processing apparatus according to claim 1,
wherein in a case where a first color scheme is present, the first color scheme corresponding to the emotion indicated by the word and satisfying a second condition regarding commonality with the representative color in the display including the image acquired by the acquisition unit, the specifying unit specifies the first color scheme.

5. The information processing apparatus according to claim 2,
wherein in a case where a first color scheme is present, the first color scheme corresponding to the emotion indicated by the word and satisfying a second condition regarding commonality with the representative color in the display including the image acquired by the acquisition unit, the specifying unit specifies the first color scheme.

6. The information processing apparatus according to claim 3,
wherein in a case where a first color scheme is present, the first color scheme corresponding to the emotion indicated by the word and satisfying a second condition regarding commonality with the representative color in the display including the image acquired by the acquisition unit, the specifying unit specifies the first color scheme.

7. The information processing apparatus according to claim 4,
wherein the specifying unit specifies a second color scheme that satisfies the second condition with respect to the representative color and a word indicating the emotion corresponding to the second color scheme, in a case where the first color scheme is not present.

8. The information processing apparatus according to claim 5,
wherein the specifying unit specifies a second color scheme that satisfies the second condition with respect to the representative color and a word indicating the emotion corresponding to the second color scheme, in a case where the first color scheme is not present.

9. The information processing apparatus according to claim 6,
wherein the specifying unit specifies a second color scheme that satisfies the second condition with respect to the representative color and a word indicating the emotion corresponding to the second color scheme, in a case where the first color scheme is not present.

10. The information processing apparatus according to claim 4,
wherein the specifying unit specifies a third color scheme corresponding to the emotion indicated by the word, and an image which is different from the image acquired by the acquisition unit and of which representative color satisfies the second condition, in a case where the first color scheme is not present.

11. The information processing apparatus according to claim 5,
wherein the specifying unit specifies a third color scheme corresponding to the emotion indicated by the word, and an image which is different from the image acquired by the acquisition unit and of which representative color satisfies the second condition, in a case where the first color scheme is not present.

12. The information processing apparatus according to claim 6,
wherein the specifying unit specifies a third color scheme corresponding to the emotion indicated by the word, and an image which is different from the image acquired by the acquisition unit and of which representative color satisfies the second condition, in a case where the first color scheme is not present.

13. An information processing apparatus comprising:
an acquisition means for acquiring an image;
an extraction means for extracting a representative color which is a color representative of the image acquired by the acquisition means;
a receiving means for receiving a designated word indicating emotion; and
a specifying means for specifying a color scheme to be applied to an image which is generated by a user, by using the word and the representative color.
